(19) United States
(12) Patent Application Publication
(10) Pub. No.: US 2008/0159113 A1
(43) Pub. Date: Jul. 3, 2008

(54) Optical Pickup Apparatus

(76) Inventors: Masahiko Nishimoto, Osaka (JP); Yasuyuki Kochi, Osaka (JP); Shinichi Ijima, Osaka (JP); Takuya Okuda, Kyoto (JP); Masayuki Ono, Osaka (JP)

Correspondence Address: MCDERMOTT WILL & EMERY LLP, 600 13TH STREET, NW, WASHINGTON, DC, 20005-3096, US

(21) Appl. No.: 11/884,207

(22) PCT Filed: Dec. 13, 2005
(86) PCT No.: PCT/JP05/23207

§ 371 Date: Aug. 13, 2007

(30) Foreign Application Priority Data
Feb. 25, 2005 (JP) 2005-051444

(51) Int. Cl. G11B 7/00

(52) U.S. Cl. 369/112.23

(57) ABSTRACT

An optical pickup apparatus including three semiconductor laser devices which emit laser beams of different wavelengths, a beam splitter, a collimator lens, a hologram device, two light receiving devices, a diffraction grating-hologram device, an integrated substrate, a light detection/source unit and diffraction gratings, whereby the three semiconductor laser devices share the beam splitter and the collimator lens.

### TECHNICAL FIELD

The present invention relates to an optical pickup apparatus for recording information to an optical recording medium and reproducing recorded information, and in particular to a technique for improving precision in assembly and cutting cost by reducing the number of components in the optical pickup apparatus.

### BACKGROUND ART

In recent years, standards for various optical recording media such as CDs (Compact Disc), DVDs, Blu-ray Discs, and High Definition DVDs have been developed and put to practical use. For this reason, there is increasing demand for an apparatus which can perform recording and reproduction regardless of the optical recording medium standard (e.g. see Japanese Patent Application Publication No. 2004-103135).

FIG. 1 shows an exemplary structure of an optical pickup apparatus according to conventional technology. As shown in FIG. 1, the optical pickup apparatus 10 includes light source/detection units 1001, 1003 and 1005, collimator lenses 1002, 1004 and 1006, beam splitters 1007 and 1009, an aberration correction device 1008, a deflecting mirror 1010 and an objective lens 1011.

The light source/detection unit 1001 and the collimator lens 1002 are for use with short-wavelength optical recording media, that is, Blu-ray Discs or High Definition DVDs. The light source/detection unit 1003 and the collimator lens 1004 are for use with medium-wavelength optical recording media, that is, DVDs. The light source/detection unit 1005 and the collimator lens 1006 are for use with long-wavelength optical recording media, that is, CDs.

### DISCLOSURE OF THE INVENTION

However, the above optical pickup apparatus 10 has a large number of components since a light source/detection unit and collimator lens are provided for each wavelength type. For this reason, cost rises, and a high degree of precision is required during assembly.

An optical pickup apparatus in which, for example, the number of light source/detection units is reduced to two has been proposed to solve this problem (ref. Japanese Patent Application Publication No. 2001-184705). However, this structure includes a separate hologram device, making it impossible to sufficiently reduce the number of components. For this reason, cost cannot be sufficiently cut, and the structure is disadvantageous in production due to the high degree of precision required during assembly.

In view of the above issue, an object of the present invention is to provide an optical pickup apparatus with a reduced number of components.

The object of the present invention is achieved by an optical pickup apparatus which includes a first semiconductor laser device; a second semiconductor laser device; a third semiconductor laser device; a collimator lens operable to collimate a laser beam emitted by each of the first, second and third semiconductor laser devices; a hologram device operable to diffract the laser beam emitted by each of the first, second, and third semiconductor laser devices after the laser beam is reflected by a recording surface of an optical recording medium; a light receiving device operable to receive the laser beam diffracted by the hologram device and output an electrical signal according to an amount of received light; and a beam splitter operable to deflect the laser beam emitted by the third semiconductor laser device, and guide the deflected laser beam to the collimator lens. Here, the first semiconductor laser device, the second semiconductor laser device, the hologram device and the light receiving device are integrally formed, and the beam splitter transmits, without deflecting, the laser beams emitted by the first and second semiconductor laser devices and the laser beam reflected by the recording surface of the optical recording medium.

According to this structure, the three collimator lenses used in conventional technology can be reduced to one, the three light source/detection units can be reduced to one, and the two beam splitters can be reduced to one. Given that beam splitters in particular are expensive, it is possible to significantly cut cost.

After the precision assembly of the first semiconductor laser device, the second semiconductor laser device, and the light receiving device has been assured by forming these devices as one piece with a semiconductor process, the positional relationship between the light source/detection unit, the beam splitter and the third semiconductor laser device need only be adjusted, thereby making it simple to ensure precision during assembly.

Also, it is possible to perform signal processing for reading information from an optical recording medium and signal processing for focusing and tracking using the same circuit since laser beams emitted by the first to third semiconductor laser devices are received by the same light receiving device. Consequently, the scale of the circuit can be reduced.

The optical pickup apparatus pertaining to the present invention includes a first semiconductor laser device; a second semiconductor laser device; a third semiconductor laser device; a collimator lens operable to collimate a laser beam emitted by each of the first, second and third semiconductor laser devices; a hologram device operable to diffract the laser beam emitted by each of the first, second, and third semiconductor laser devices after the laser beam is reflected by a recording surface of an optical recording medium; a light receiving device operable to receive the laser beam diffracted by the hologram device and output an electrical signal according to an amount of received light; and a beam splitter operable to deflect the laser beams emitted by the first and second semiconductor laser devices, and guide the deflected laser beam to the collimator lens. Here, the first semiconductor laser device, the second semiconductor laser device, the hologram device and the light receiving device are integrally formed, and the beam splitter transmits, without deflecting, the laser beam emitted by the third semiconductor laser device and the laser beam reflected by the recording surface of the optical recording medium. According to this structure, similar effects to those mentioned above can be obtained.

In the optical pickup apparatus pertaining to the present invention, the first semiconductor laser device may emit a laser beam having a wavelength of 650 nm, the second semiconductor laser device may emit a laser beam having a wavelength of 780 nm, and the third semiconductor laser device may emit a laser beam having a wavelength of 405 nm. According to this structure, it is possible to obtain an optical pickup apparatus compatible with CDs, DVDs and Blu-ray Discs or High Definition DVDs. It is also possible to manufacture the semiconductor laser device for CDs and the semiconductor laser device for DVDs using similar materials. On the other hand, manufacturing the third semiconductor laser device for Blu-ray Discs or High Definition DVDs together in the same semiconductor process as the first and second semiconductor laser devices is difficult and poor in terms of cost-efficiency. Consequently, using a semiconductor laser device compliant with Blu-ray Discs or High Definition DVDs as the third semiconductor laser device enables the number of components to be reduced without increasing cost.

In the optical pickup apparatus pertaining to the present invention, the first semiconductor laser device and the second semiconductor laser device may be integrally formed as a monolithic semiconductor laser device. According to this structure, it is possible to have both laser beams emitted by the first and second semiconductor laser devices travel near an optical axis of the collimator lens. Consequently, it is possible to precisely focus each laser beam on pits in the optical recording medium.

In the optical pickup apparatus pertaining to the present invention, the laser beams emitted by the first and third semiconductor laser devices may both pass through the collimator lens with a principal ray of each laser beam substantially aligned with an optical axis of the collimator lens. According to this structure, it is possible to cause the laser beams emitted by the first and third semiconductor laser devices to pass through the optical axis of the collimator lens, thereby enabling precise focusing of these laser beams on pits in the optical recording medium. This is particularly ideal if the first semiconductor laser device emits a laser beam with a shorter wavelength than the laser beam emitted by the second semiconductor laser device.

The optical pickup apparatus pertaining to the present invention may further include a first diffraction grating operable to diffract the laser beams emitted by the first and second semiconductor laser devices; a second diffraction grating operable to diffract the laser beam emitted by the third semiconductor laser device; and a generation unit operable to generate a focus error signal and a tracking error signal from the electrical signal output by the light receiving device. Here, the first diffraction grating may be disposed between the beam splitter and the first and second semiconductor laser devices on an optical path of the laser beams emitted by the first and second semiconductor laser devices, and the second diffraction grating may be disposed between the beam splitter and the third semiconductor laser device on and optical path of the laser beam emitted by the third semiconductor laser device. According to this structure, it is possible to perform appropriate focusing and tracking in the optical pickup apparatus pertaining to the present embodiment.

### BRIEF DESCRIPTION OF THE DRAWINGS

FIG. 1 shows an exemplary structure of an optical pickup apparatus according to conventional technology;

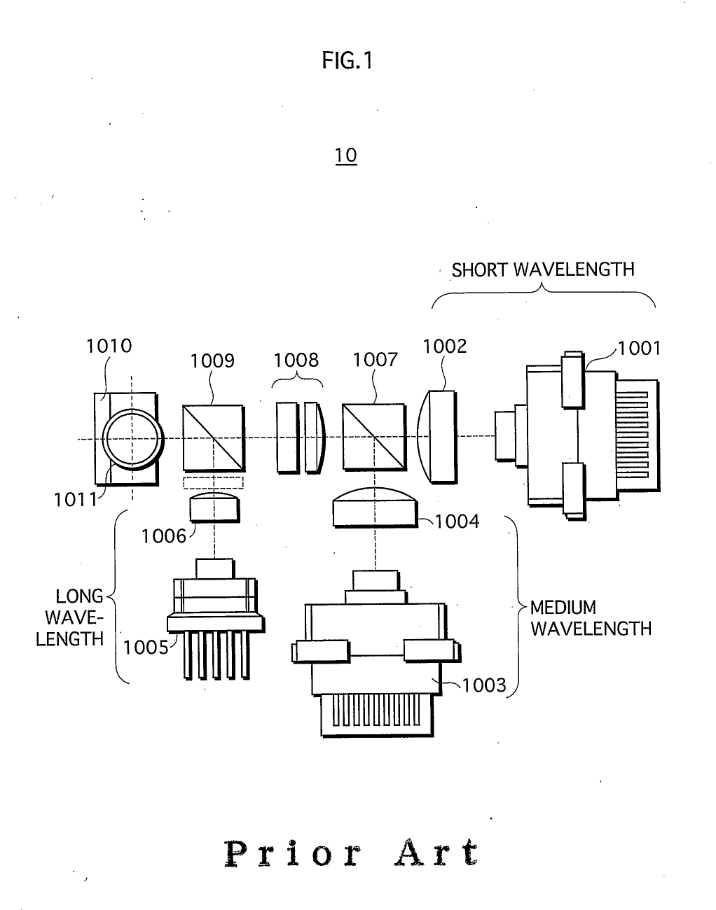

FIG. 2 is a schematic view of a main structure of an optical pickup apparatus according to embodiment 1 of the present invention;

FIG. 3 shows an optical path of a laser beam emitted by a semiconductor laser device 101 until the beam is incident on light receiving devices 107 and 108, according to embodiment 1 of the present invention;

FIG. 4 shows an optical path of a laser beam emitted by a semiconductor laser device 102 until the beam is incident on the light receiving devices 107 and 108, according to embodiment 1 of the present invention;

FIG. 5 shows an optical path of a laser beam emitted by a semiconductor laser device 112 until the beam is incident on the light receiving devices 107 and 108, according to embodiment 1 of the present invention;

FIG. 6 is a schematic view of a main structure of an optical pickup apparatus according to embodiment 2 of the present invention;

FIG. 7 shows an optical path of a laser beam emitted by a semiconductor laser device 501 until the beam is incident on light receiving devices 507 and 508, according to embodiment 2 of the present invention;

FIG. 8 shows an optical path of a laser beam emitted by a semiconductor laser device 502 until the beam is incident on the light receiving devices 507 and 508, according to embodiment 2 of the present invention;

FIG. 9 shows an optical path of a laser beam emitted by a semiconductor laser device 512 until the beam is incident on the light receiving devices 507 and 508, according to embodiment 2 of the present invention; and

FIG. 10 is a schematic view of a main structure of an optical pickup apparatus according to embodiment 3 of the present invention.

### BEST MODE FOR CARRYING OUT THE INVENTION

Embodiments of the optical pickup apparatus pertaining to the present invention are described below with reference to the drawings.

### Embodiment 1

First, a structure of the optical pickup apparatus pertaining to the present embodiment is described, and a description of operations follows thereafter.

(1) Structure of the Optical Pickup Apparatus

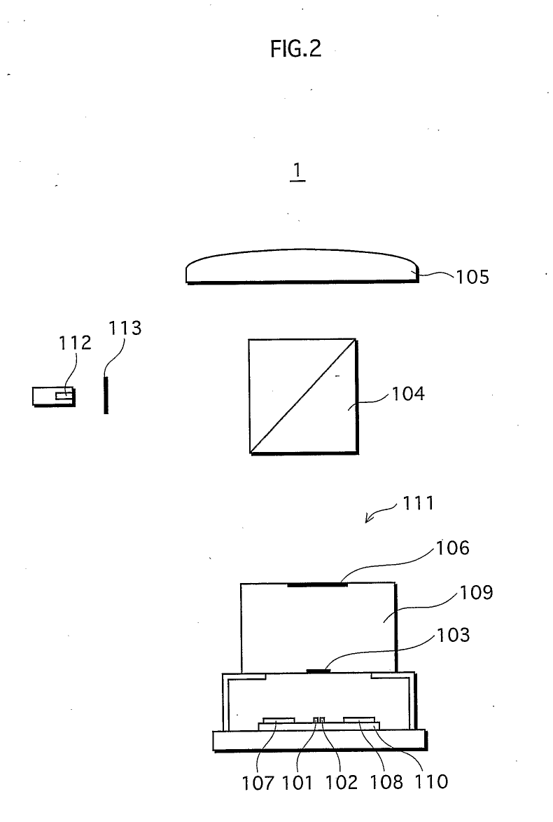

FIG. 2 is a schematic view of a main structure of an optical pickup apparatus according to embodiment 1 of the present invention. As shown in FIG. 2, an optical pickup apparatus 1 includes a beam splitter 104, a collimator lens 105, a semiconductor laser device 112, a diffraction grating 113 and a light source/detection unit 111. Although not shown in the figure, a ¼ wavelength plate is disposed between the beam splitter 104 and the collimator lens 105.

The light source/detection unit 111 includes a diffraction grating-hologram device 109 and an integrated substrate 110. Semiconductor laser devices 101 and 102, and light receiving devices 107 and 108 are mounted on the integrated substrate 110. The diffraction grating-hologram device 109 consists of a diffraction grating 103 and a hologram device 106 which have been integrally formed.

The semiconductor laser device 112 is disposed such that a principal ray of emitted light is orthogonal to an optical axis of the collimator lens 105. A laser beam emitted by the semiconductor laser device 112 passes through the diffraction grating 113 and is incident to the beam splitter 104.

The semiconductor laser devices 101, 102 and 112 respectively emit 650 nm, 780 nm and 405 nm laser beams in compliance with the DVD, CD and Blu-ray Disc standards. The beam splitter 104 transmits the 650 nm and 780 nm beams emitted by the semiconductor laser devices 101 and 102, but reflects the 405 nm beam emitted by the semiconductor laser device 112, and guides the 405 nm beam to the collimator lens 105. The beam splitter 104 also transmits reflected light from an optical recording medium, and guides the reflected light to the light receiving devices 107 and 108.

(2) Operations of the Optical Pickup Apparatus 1

The following describes operations of the optical pickup apparatus 1 pertaining to the present embodiment. After determining the standard of the optical recording medium to be irradiated with a laser beam, a laser beam is irradiated onto the optical recording medium using a semiconductor laser device compliant with the determined standard. As previously mentioned, in the present embodiment the semiconductor laser devices 101, 102 and 112 respectively emit laser beams of wavelengths compliant with the DVD, CD and Blu-ray Disc standards.

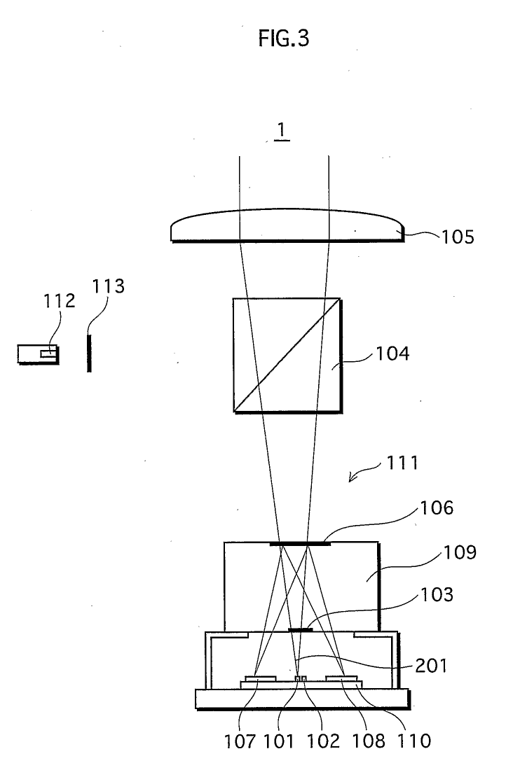

FIG. 3 shows an optical path of a laser beam emitted by a semiconductor laser device 101 until the beam is incident on light receiving devices 107 and 108. As shown in FIG. 3, a laser beam 201 emitted by the semiconductor laser device 101 is diffracted by the diffraction grating 103 into a main beam of zero-order diffracted light and a sub-beam of +first-order diffracted light. After passing through the beam splitter 104, the laser beam 201 is collimated by the collimator lens 105, and then focused on a recording surface of the optical recording medium by an objective lens (not depicted). The reflected beam 201 from the recording surface is incident on the hologram device 106 after following the same optical path in reverse. The +first-order diffracted light is then incident on the light receiving devices 107 and 108.

At least four light receiving devices are provided, and are disposed on a periphery of the semiconductor laser devices 101 and 102. For example, a focus error signal may be detected using the Spot Size Detection method, and a tracking error signal may be detected using the Differential Phase Detection/Differential Push Pull method. Note that other methods may be used.

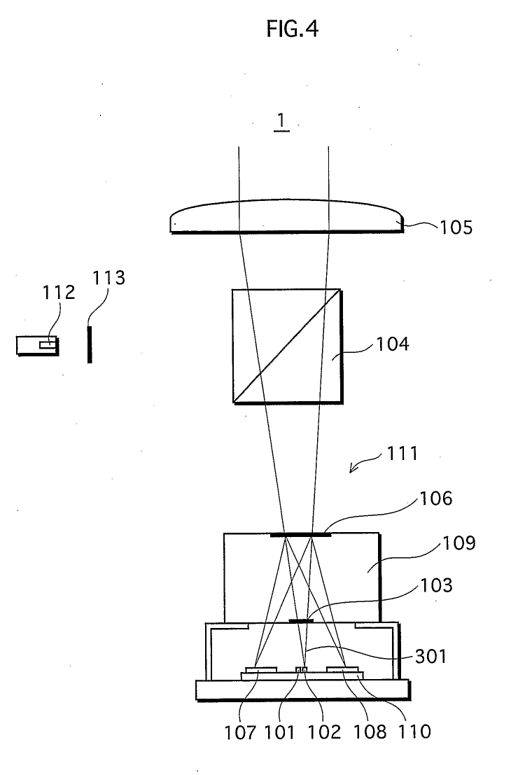

FIG. 4 shows an optical path of a laser beam emitted by a semiconductor laser device 102 until the beam is incident on the light receiving devices 107 and 108. As shown in FIG. 4, a laser beam 301 emitted by the semiconductor laser device 102 travels an optical path generally similar to that of the laser beam 201 emitted by the semiconductor laser device 101, and is incident on the light receiving devices 107 and 108.

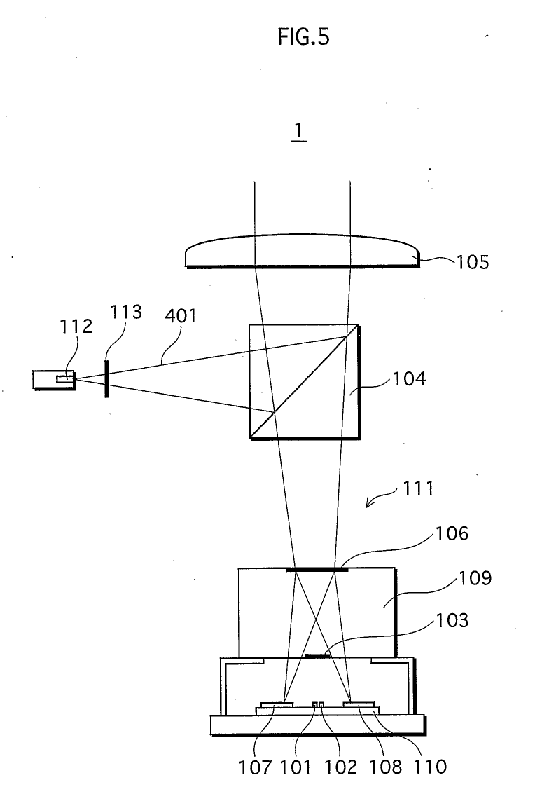

FIG. 5 shows an optical path of a laser beam emitted by a semiconductor laser device 112 until the beam is incident on the light receiving devices 107 and 108. As shown in FIG. 5, a laser beam 401 emitted by the semiconductor laser device 112 is diffracted by the diffraction grating 113 into a main beam of zero-order diffracted light and a sub-beam of +first-order diffracted light. The laser beam 401 is then guided to the collimator lens 105 by the beam splitter 104. The subsequent optical path is similar to that of the laser beam 201 emitted by the semiconductor laser device 101.

According to this structure, it is possible to support the three different DVD, CD and Blu-ray Disc standards, while reducing the number of components by sharing the hologram device 106, the collimator lens 105, the objective lens and the light receiving devices 107 and 108 among the three standards. Consequently, the size of the optical pickup apparatus is reduced, and it is possible to simultaneously simplify the apparatus and cut cost.

Given that light emitted from the semiconductor laser 112 does not pass through a hologram device on the optical path from the semiconductor laser device 112 to the optical recording medium, good efficiency is achieved with little loss of light.

Furthermore, the light source/detection unit 111 is constituted from the diffraction grating-hologram device 109 and the integrated substrate 110, making assembly simple. Consequently, it is possible to realize a high degree of precision in assembly.

Also, given that the collimator lens 105 has two optical axes which are orthogonal to each other, it is possible to improve the precision of recording and reproducing with respect to the two standards (i.e. DVD and Blu-ray Disc) which require higher precision, by aligning one of the optical axes with the principal ray of the laser beam emitted by the semiconductor laser device 101, while aligning the other optical axis with the principal ray of the laser beam emitted by the semiconductor laser device 112.

### Embodiment 2

The following describes an optical pickup apparatus pertaining to embodiment 2 of the present invention. The optical pickup apparatus pertaining to the present embodiment has a structure generally similar to the optical pickup apparatus pertaining to embodiment 1, although there is a difference in the positional relationship between the collimator lens and the other members. This description focuses solely on this difference.

(1) Structure of the Optical Pickup Apparatus

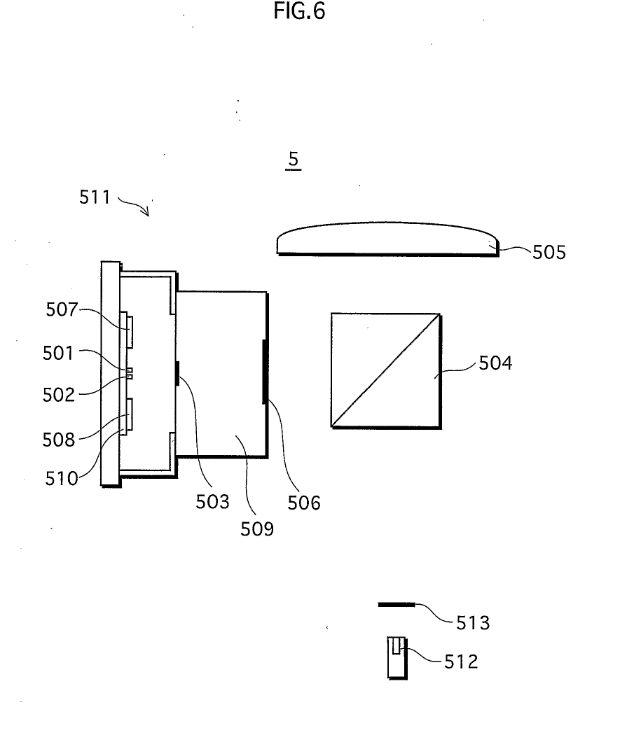

FIG. 6 is a schematic view of a main structure of the optical pickup apparatus according to the present embodiment. As shown in FIG. 6, an optical pickup apparatus 5 has a similar construction to the optical pickup apparatus 1 pertaining to embodiment 1. The optical pickup apparatus 5 includes semiconductor lasers 501, 502 and 512, a diffraction grating 503, a beam splitter 504, a collimator lens 505, a hologram device 506, light receiving devices 507 and 508, a diffraction grating-hologram device 509, an integrated substrate 510, a light source/detection unit 511 and a diffraction grating 513. Although not shown in the figure, a ¼ wavelength plate is disposed between the beam splitter 504 and the collimator lens 505.

Note that unlike embodiment 1, the collimator lens 505 is disposed in opposition to the semiconductor laser device 512, with the beam splitter 504 sandwiched therebetween in the present embodiment. In other words, the collimator lens 505 is disposed such that a principal ray of a laser beam emitted by the semiconductor laser device 512 is substantially aligned with an optical axis of the collimator lens 505.

The beam splitter 504 reflects 650 nm and 780 nm light emitted by the semiconductor laser devices 501 and 502, and guides the light to the collimator lens 505, while transmits 405 nm light emitted by the semiconductor laser device 512. The beam splitter 504 also reflects light reflected from an optical recording medium, and guides the reflected light to the light receiving devices 507 and 508.

(2) Operations of the Optical Pickup Apparatus 5

The following describes operations of the optical pickup apparatus 5 pertaining to the present embodiment. Similarly to embodiment 1, the semiconductor laser devices 501, 502 and 503 in the present embodiment each emit a laser beam according to a standard of the optical recording medium.

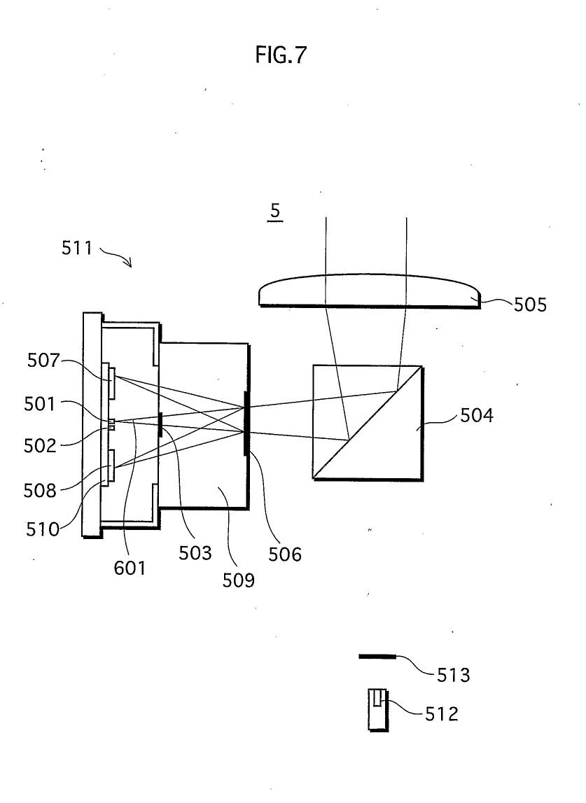

FIG. 7 shows an optical path of a laser beam emitted by the semiconductor laser device 501. As shown in FIG. 7, a laser beam 601 emitted from the semiconductor laser device 501 passes through the diffraction grating 503, whereafter a principal ray is deflected 90 degrees by the beam splitter 504 and guided to the collimator lens 505. The laser beam is then reflected by the recording surface of the optical recording medium, deflected 90 degrees again by the beam splitter 504, and guided to the hologram device 506. Next, ± first-order diffracted light resulting from the hologram device 506 is incident on the light receiving devices 507 and 508.

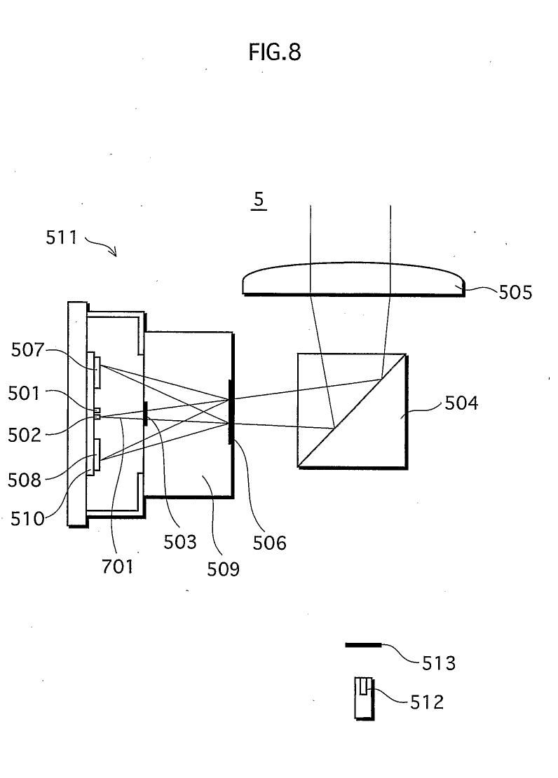

FIG. 8 shows an optical path of a laser beam emitted by the semiconductor laser device 502. As shown in FIG. 8, a laser beam 701 emitted by the semiconductor laser device 502 travels an optical path generally similar to that of the laser beam 201 emitted by the semiconductor laser device 501.

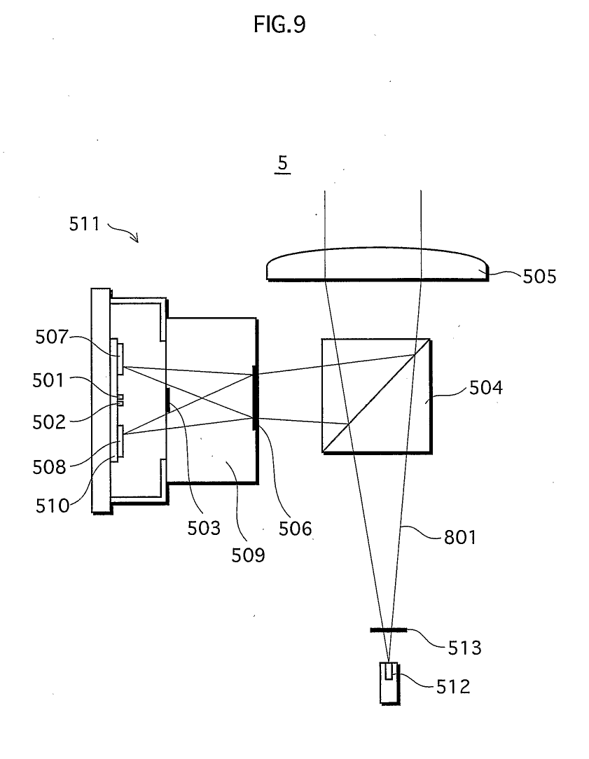

FIG. 9 shows an optical path of a laser beam emitted by the semiconductor laser device 512. As shown in FIG. 9, a laser beam 801 emitted by the semiconductor laser device 512 is incident on the collimator lens 505 after passing through the diffraction grating 513 and the beam splitter 504. The subsequent optical path is similar to that of the laser beam 601 emitted by the semiconductor laser device 501.

Similarly to embodiment 1, the present embodiment also enables an improvement in the precision of recording and reproducing with respect to the two standards (i.e. DVD and Blu-ray Disc) which require higher precision, by aligning one of the optical axes with the principal ray of the laser beam emitted by the semiconductor laser device 501, while aligning the other optical axis with the principal ray of the laser beam emitted by the semiconductor laser device 512.

The other effects of embodiment 1 can also be obtained with the optical pickup apparatus of the present embodiment.

### Embodiment 3

The following describes an optical pickup apparatus pertaining to embodiment 3 of the present invention. The optical pickup apparatus pertaining to the present embodiment has a structure generally similar to the optical pickup apparatus pertaining to embodiment 1, although there is a difference in a structure of the light emitting devices. This description focuses solely on this difference.

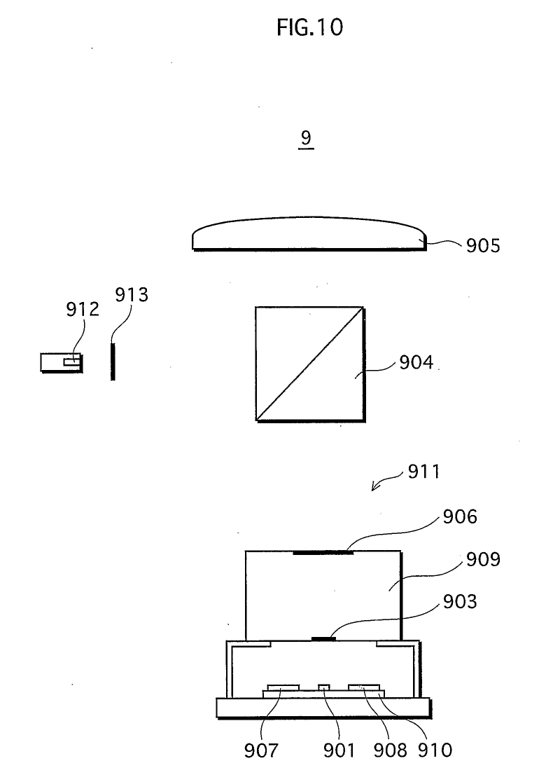

FIG. 10 is a schematic view of a main structure of the optical pickup apparatus according to the present embodiment. As shown in FIG. 10, an optical pickup apparatus 9 has a structure generally similar to that of the optical pickup apparatus 1 pertaining to embodiment 1. The optical pickup apparatus 9 includes semiconductor laser devices 901 and 912, a diffraction grating 903, a beam splitter 904, a collimator lens 905, a hologram device 906, light receiving devices 907 and 908, a diffraction grating-hologram device 909, an integrated substrate 910, a light source/detection unit 911 and a diffraction grating 913.

The semiconductor laser device 901 is a monolithic two-wavelength semiconductor laser device. The light beam emittance interval precision of the semiconductor laser devices 101 and 102 pertaining to embodiment 1 is dependent on the precision of assembly. The light beam emittance interval precision of the monolithic two-wavelength semiconductor laser device, however, is dependent on diffusion precision. Consequently, a higher light beam emittance interval precision can be achieved when using the monolithic two-wavelength semiconductor laser device. This is turn makes it possible to improve the precision of recording and reproducing with respect to optical recording media that comply with standards corresponding to the wavelengths of the laser beams emitted by the semiconductor laser device 901.

Note that effects obtained with the optical pickup apparatus pertaining to embodiment 1 can also be obtained with the optical pickup apparatus 9 pertaining to the present embodiment.

### Variations

Although having been described above based on the preferred embodiments, the present invention is of course not limited to the above-mentioned embodiments. The following variations may also be implemented.

(1) The above embodiments are described in terms of the ¼ wavelength plate being disposed between the beam splitter and the collimator lens, although the present invention is not limited to this. Alternatively, the 1/4 wavelength plate may be disposed between the collimator lens and the objective lens. Effects similar to those mentioned above can be obtained even with this structure.

(2) Although not particularly mentioned in the above embodiments, the objective lens provided in the optical pickup apparatus may be composed of a single lens, or may be a combination lens composed of multiple lenses. In either case, there is no change to the effects of the present invention.

(3) Embodiment 1 is described solely in terms of replacing the semiconductor laser devices 101 and 102 of embodiment 1 with the monolithic two-wavelength semiconductor laser device, although the present invention is not limited to this. Alternatively, the monolithic two-wavelength semiconductor laser device may be applied to the optical pickup apparatus pertaining to embodiment 2. Doing so would improve the light beam emittance interval precision of the optical pickup apparatus pertaining to embodiment 2, and enable an improvement in the precision of recording to and reproducing from the optical recording medium.

(4) The above embodiments are described taking Blu-ray Disc as an example standard that uses a laser beam with the shortest wavelength in the embodiments, although the present invention is not limited to this. Alternatively, similar effects may be obtained with High Definition DVD. Furthermore, it is possible to make the optical pickup apparatus compatible with the standards of all optical recording media compatible with a 405 nm semiconductor laser.

### INDUSTRIAL APPLICABILITY

The optical pickup apparatus pertaining to the present invention is useful as a small device which accurately performs recording and reproduction.

1. An optical pickup apparatus comprising:
a first semiconductor laser device;
a second semiconductor laser device;
a third semiconductor laser device;
a collimator lens operable to collimate a laser beam emitted by each of the first, second and third semiconductor laser devices;
a hologram device operable to diffract the laser beam emitted by each of the first, second, and third semiconductor laser devices after the laser beam is reflected by a recording surface of an optical recording medium;
a light receiving device operable to receive the laser beam diffracted by the hologram device and output an electrical signal according to an amount of received light; and
a beam splitter operable to deflect the laser beam emitted by the third semiconductor laser device, and guide the deflected laser beam to the collimator lens, wherein
the first semiconductor laser device, the second semiconductor laser device, the hologram device and the light receiving device are integrally formed, and
the beam splitter transmits, without deflecting, the laser beams emitted by the first and second semiconductor laser devices and the laser beam reflected by the recording surface of the optical recording medium.

2. An optical pickup apparatus comprising:
a first semiconductor laser device;
a second semiconductor laser device;
a third semiconductor laser device;
a collimator lens operable to collimate a laser beam emitted by each of the first, second and third semiconductor laser devices;
a hologram device operable to diffract the laser beam emitted by each of the first, second, and third semiconductor laser devices after the laser beam is reflected by a recording surface of an optical recording medium;
a light receiving device operable to receive the laser beam diffracted by the hologram device and output an electrical signal according to an amount of received light; and
a beam splitter operable to deflect the laser beams emitted by the first and second semiconductor laser devices, and guide the deflected laser beam to the collimator lens, wherein
the first semiconductor laser device, the second semiconductor laser device, the hologram device and the light receiving device are integrally formed, and
the beam splitter transmits, without deflecting, the laser beam emitted by the third semiconductor laser device and the laser beam reflected by the recording surface of the optical recording medium.

3. An optical pickup apparatus as in claim 1, wherein
the first semiconductor laser device emits a laser beam having a wavelength of 650 nm;
the second semiconductor laser device emits a laser beam having a wavelength of 780 nm; and
the third semiconductor laser device emits a laser beam having a wavelength of 405 nm.

4. An optical pickup apparatus as in claim 1, wherein
the first semiconductor laser device and the second semiconductor laser device are integrally formed as a monolithic semiconductor laser device.

5. An optical pickup apparatus as in claim 1, wherein
the laser beams emitted by the first and third semiconductor laser devices both pass through the collimator lens with a principal ray of each laser beam substantially aligned with an optical axis of the collimator lens.

6. An optical pickup apparatus as in claim 1, further comprising:
a first diffraction grating operable to diffract the laser beams emitted by the first and second semiconductor laser devices;
a second diffraction grating operable to diffract the laser beam emitted by the third semiconductor laser device; and
a generation unit operable to generate a focus error signal and a tracking error signal from the electrical signal output by the light receiving device, wherein
the first diffraction grating is disposed between the beam splitter and the first and second semiconductor laser devices on an optical path of the laser beams emitted by the first and second semiconductor laser devices, and
the second diffraction grating is disposed between the beam splitter and the third semiconductor laser device on and optical path of the laser beam emitted by the third semiconductor laser device.

7. An optical pickup apparatus as in claim 2, wherein
the first semiconductor laser device emits a laser beam having a wavelength of 650 nm;
the second semiconductor laser device emits a laser beam having a wavelength of 780 nm; and
the third semiconductor laser device emits a laser beam having a wavelength of 405 nm.

8. An optical pickup apparatus as in claim 2, wherein
the first semiconductor laser device and the second semiconductor laser device are integrally formed as a monolithic semiconductor laser device.

9. An optical pickup apparatus as in claim 2, wherein
the laser beams emitted by the first and third semiconductor laser devices both pass through the collimator lens with a principal ray of each laser beam substantially aligned with an optical axis of the collimator lens.

10. An optical pickup apparatus as in claim 2, further comprising:
a first diffraction grating operable to diffract the laser beams emitted by the first and second semiconductor laser devices;
a second diffraction grating operable to diffract the laser beam emitted by the third semiconductor laser device; and
a generation unit operable to generate a focus error signal and a tracking error signal from the electrical signal output by the light receiving device, wherein
the first diffraction grating is disposed between the beam splitter and the first and second semiconductor laser devices on an optical path of the laser beams emitted by the first and second semiconductor laser devices, and
the second diffraction grating is disposed between the beam splitter and the third semiconductor laser device on and optical path of the laser beam emitted by the third semiconductor laser device.
